(19) United States
(12) Patent Application Publication
(10) Pub. No.: US 2002/0141906 A1
(43) Pub. Date: Oct. 3, 2002

(54) Microtiter plate sealing cover with well identifiers

(75) Inventor: Philip A. Caramanica JR., Dumfries, VA (US)

Correspondence Address: ROTHWELL, FIGG, ERNST & MANBECK, P.C., 1425 K STREET, N.W., SUITE 800, WASHINGTON, DC, 20005, US

(73) Assignee: American Type Culture Collection, Manassas, VA

(21) Appl. No.: 09/820,638

(22) Filed: Mar. 30, 2001

(51) Int. Cl. B01L 3/00

(52) U.S. Cl. 422/102; 435/305.1; 435/305.2; 435/305.3; 435/288.3; 435/288.4; 436/165

(57) ABSTRACT

An adhesive backed covering for use on a microtiter plate is disclosed. The covering comprises labels printed or embossed thereon which will align on top of individual wells when the cover is placed onto the microtiter plate. Preferably each label will be unique to uniquely identify each well of the microtiter plate. The use of these covers aids in the manual identification of individual wells of microtiter plates thereby minimizing human error. Preferably the covers can easily be penetrated by a pipet tip or other extraction device, such as a wooden applicator or toothpick, to allow easy access to individual wells while protecting other wells which remain sealed.

### BACKGROUND OF THE INVENTION

Microtiter plates are widely used in the fields of biology and biotechnology. These plates commonly have either 96 or 384 wells arranged in either an 8×12 or a 24×16 array. These are used for a variety of purposes including, but not limited to, cell culture, polymerase chain reaction, storage of samples, etc. The microtiter plates have small, closely spaced wells which are designed for samples of up to approximately 125 μL (96 well plate) or 30 μL (384 well plate). These are in general designed to be disposable and are usually made of a plastic such as polypropylene. Microtiter plates are often designed to be covered, either with a plastic cover which is slipped over the top of the plate or with a seal which can be placed over the microtiter plate and held in place by an adhesive backing. Microtiter plates and their coverings are commercially sold by several companies, e.g., MJ Research (Waltham, Mass.) sells a variety of 96 and 384 well microtiter plates as well as seals including a sealing film and an aluminized foil. These seals can be pierced by a pipet tip to allow access to the wells without removing the seal from all of the wells. The seals prevent evaporation during cold storage at −20° C. or 4° C. as well as at 105° C. These aluminized seals from MJ Research also can include a DNAse and RNAse free sealing surface. The purpose of such seals is to prevent evaporation, to prevent leakage during storage, and to prevent contamination.

In use, it is necessary for the sample in the correct well to be selected. Automated robotic systems are programmed to move to the appropriate locations as specified by the user. Automation is costly and deemed unnecessary by many companies and automation presents space issues. Consequently, much work is performed manually, and it is difficult for humans to accurately insert a pipet into the correct position, especially with 384 well microtiter plates. This results in errors being made. Some efforts have been made to overcome this problem. The microtiter plates are often manufactured such that the rows and columns are labeled across the top and side of the plate. For example, the columns may be labeled from 1-12 across the top of a 96 well microtiter plate while the left-hand side is marked A-H. Each individual well can be given a unique identifier (e.g., A1, C5, etc.) and the labels across the top and side aid in identifying the correct well. Nonetheless, in practice human error still occurs because it is difficult to move accurately both down and across the columns and rows since the wells are so closely spaced together. The fact that the microtiter plates are usually made of clear plastic and often contain a clear solution makes it that much more difficult to locate the proper well since there are no guideposts except along the edges of the microtiter plates. Furthermore, microtiter plates are often stored in the cold, often at −80° C., and frost often covers the markings on the edges making it difficult to see them.

One method used to aid in accurately locating the proper well is to place the microtiter plate on top of a labeled grid. This method includes its own drawbacks. One such problem is that if the grid is not aligned exactly correctly, the wrong labeling will appear beneath each well. It is also easy for the plate to accidentally slide while handling the microtiter plate thereby misaligning the plate with the labeled grid. Furthermore, if the microtiter plate includes an opaque cover or is difficult to see through because of frost or condensation, or if the wells include samples which prevent one from seeing through the microtiter plate, this method will not be usable.

A method being developed to solve the problem encompasses the step of shining lasers through the wells to correctly mark the desired well. The microtiter plate is placed into a tray connected to a laser and the laser will highlight the correct well. However, if the laser light is from below the microtiter plate, the laser light cannot be seen through an opaque cover if such a cover is used and is difficult to see even if a plastic cover is used. Lasers from above are difficult to build onto the plate and involve aiming by the user for each individual plate and any repeat plates. Plastic strips extending across both the vertical and horizontal planes of the plate (the intersection of which is the desired well) present functional problems such as the inability to fit in a hood and insertion/removal of microtiter plates from the apparatus. Further, these devices can prove expensive both in initial cost and maintenance.

There remains a need for a manual method for accurately identifying the correct microtiter well on a microtiter plate so that the desired clone, PCR amplification product, cell culture, etc. is pipetted.

### SUMMARY OF THE INVENTION

The invention is drawn to a method for clearly marking wells on microtiter plates to allow a person to manually select the desired well correctly without accidentally inserting a pipet tip or other device, e.g., a wooden applicator, a toothpick, etc., into an incorrect, neighboring well.

One aspect of the invention is a microtiter plate sealing cover which includes a label imprinted over each well allowing the user to directly identify and locate the desired well without having to look to the edges of the microtiter plate.

Another aspect of the invention is a method for accurately locating by manual means a specified well on a microtiter plate.

### BRIEF DESCRIPTION OF THE FIGURES

FIG. 1A is an example of a sealing cover for a 96 well microtiter plate with individual and unique labels which align over the wells of the microtiter plate when the cover is attached to the microtiter plate. Also shown are a row of numbers and a column of letters which may be desired but which do not align over any wells.

FIG. 1B is an example of a sealing cover for a 384 well microtiter plate with individual and unique labels which align over the wells of the microtiter plate when the cover is attached to the microtiter plate. Also shown are a row of numbers and a column of letters which may be desired but which do not align over any wells.

### DETAILED DESCRIPTION OF THE INVENTION

Microtiter plates are widely used in the fields of biology and biotechnology and related fields. High-throughput methods make use of small volumes of numerous samples and have been adapted to use with microtiter plates with their 96 or 384 well capacities. Microtiter plates are also widely used in manual, low-throughput methods. Whereas automated systems can accurately locate every individual well on a microtiter plate, humans often tend to miss the correct well and will mistakenly pipet or extract a sample from a neighboring well. This is especially true of the 384 well microtiter plates. These 384 well plates have wells on the order of 3 millimeters across with 1 millimeter wide walls separating neighboring wells. The difficulties of accurately inserting a pipet tip or other device into the one desired well were outlined above in the Background of the Invention.

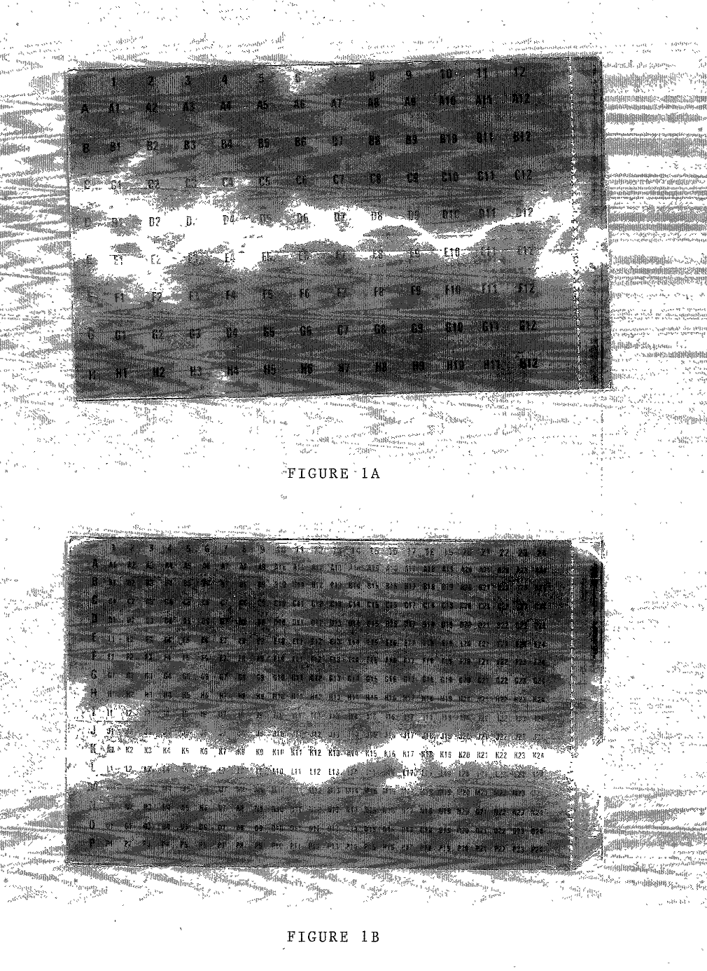

The present invention overcomes the problems inherent in the prior art solutions. The present invention utilizes an adhesive cover which is placed onto the top of the microtiter plates. These adhesive covers are printed or embossed with a unique identifier for each well, e.g., each column of a 96 well plate can be identified by a number from 1-12 and each row of a 96 well plate can be identified by a letter from A-H. Other labeling systems can of course be used, but this is the conventional system. The adhesive cover will comprise 96 individual markings which are printed or embossed on the cover such that they are each directly over one well. FIG. 1A shows one example of such a cover for a 96 well microtiter plate. FIG. 1B shows one example of an adhesive cover for a 384 well plate. In these Figures, a row of numbers across the top and a column of letters down the side of the adhesive cover are also shown, but these are not required. If one wants, e.g., a sample from well F6, one can insert a pipet tip or other device directly through the adhesive cover exactly at the spot labeled F6. The person need not look to the top row of the plate to look for a number nor to the side of the plate to look for a letter. It is also unnecessary to manually count rows across and down which some persons do using the prior art microtiter plates without a labeled cover. Instead, the desired well is directly labeled and one can simply puncture directly where the label is. The prior art seals and covers did not include labels directly over the wells, rather they had labels, if at all, only along the edges of the microtiter plates. The meaning of the term “label” as applied to the adhesive backed cover of the invention is a marking on the cover which can be read or identified by a person.

The method of placing an adhesive cover with a unique label over each individual well of a microtiter plate includes several other advantages. The adhesive cover seals the plate thereby preventing evaporation or accidental spillage. The cover also prevents accidental contamination of the wells. Even when one or several samples have been taken from a plate covered with an adhesive label, the remaining samples remain sealed and can be used at a later time. Because the cover is never completely removed, which would be the case if one used a plastic cover which needed to be removed whenever a sample was taken, there is much less chance of contamination of the samples. If desired, once a single sample is taken from a well or from several wells, if only a portion of the sample in the well is used, it is possible to again locate that well easily, even though its label has been destroyed by puncturing with a pipet tip, by using the labels of neighboring wells as a guide. It is also possible to apply a second adhesive cover on top of the first adhesive cover, thereby resealing any wells which may have had their seals punctured. This allows the microtiter plates to be stored again and to have access to all of the samples including those which have been sampled but which still have material remaining in the wells. This process can be repeated by application of a third, fourth, etc., adhesive cover each time the microtiter plate is used. If desired, a plastic top that is often sold with the microtiter plate as a cover can be placed over the adhesive seal. This will further protect the adhesive backed seal from accidentally being punctured which could otherwise happen, such as when persons rummage through a freezer while the microtiter plate is in storage.

The adhesive backed covers are especially useful for manual methods performed by humans, but these covers themselves are preferably manufactured by nonmanual means which will accurately imprint or emboss the labels in the exactly correct positions and will draw the labels in a clear, easily readable style to further minimize human error. The adhesive backed covers preferably are cut to the size of the microtiter plates so that they can easily be aligned on the plate. These will preferably be made such that they include a peel-off backing which is removed just prior to placing the adhesive-backed cover onto the microtiter plate. If desired, these covers can be made RNAse and DNAse free as exemplified by the MJ Research Microseal™ F aluminized foils.

Aluminum foil is a preferred adhesive backed cover although other covers such as made of plastic or other easily penetrated material can be used. Printing on aluminum foil is difficult, but those in the printing arts have learned to do so. The adhesive backed covers could be labeled by “engraving” or “embossing” the aluminum foil, but printing on the foil is preferred since printing is easier to see and less prone to accidental markings obscuring the labeling. Black ink in block letters is preferred, but other colors of ink and other styles of lettering can be used.

What is claimed is:

1. A sheet of foil or plastic comprising two surfaces with a first surface comprising an array of labels and a second surface comprising an adhesive surface.

2. The sheet of claim 1 further comprising a removable backing contacting said adhesive surface.

3. The sheet of claim 1 wherein said sheet comprises aluminum.

4. The sheet of claim 1 wherein said sheet comprises plastic.

5. The sheet of claim 1 wherein said sheet has dimensions suitable to fit onto the top surface of a microtiter plate thereby covering wells of said microtiter plate.

6. The sheet of claim 1 wherein said array of labels comprises unique identifiers.

7. The sheet of claim 6 wherein said identifiers are located to each align over one well of a 96 well microtiter plate and wherein each well has a unique identifier over it.

8. The sheet of claim 6 wherein said identifiers are located to each align over one well of a 384 well microtiter plate and wherein each well has a unique identifier over it.

9. The sheet of claim 1 wherein said labels comprise an ink.

10. The sheet of claim 1 wherein said labels are embossed on said sheet.

11. The sheet of claim 1 wherein said sheet can manually be penetrated by a pipet tip or other device.

12. The sheet of claim 1 wherein said sheet is DNAse and RNAse free.

13. A microtiter plate comprising the sheet of claim 1.

14. A method of aiding a person to locate a specified well of a microtiter plate, said method comprising applying a sheet on top of said microtiter plate wherein said sheet comprises labels which align over individual wells of said microtiter plate.

15. The method of claim 14 wherein said labels uniquely identify each individual well.

16. The method of claim 14 wherein said sheet comprises an adhesive backing to hold said sheet on said microtiter plate.

17. The method of claim 14 wherein said sheet can be manually penetrated by a pipet tip.

18. The method of claim 14 wherein said microtiter plate comprises 96 wells.

19. The method of claim 14 wherein said microtiter plate comprises 384 wells.

20. A method of sealing a microtiter plate comprising placing a sheet with an adhesive backing onto said microtiter plate wherein said sheet comprises labels which align over individual wells of said microtiter plate.

21. The method of claim 20 wherein said labels uniquely identify each individual well.

22. The method of claim 20 wherein said sheet can be manually penetrated by a pipet tip or other device.

23. The method of claim 20 wherein said microtiter plate comprises 96 wells.

24. The method of claim 20 wherein said microtiter plate comprises 384 wells.
